(19) United States
(12) Patent Application Publication
(10) Pub. No.: US 2015/0379839 A1
(43) Pub. Date: Dec. 31, 2015

(54) RFID-BASED PRE-SALES/AFTER-SALES INFORMATION COLLECTION AND ANALYSIS SYSTEM AND IMPLEMENTATION METHOD

(71) Applicant: C2Analytics Company Limited, Kowloon (HK)

(72) Inventors: San Cheong Cheung, Kowloon (HK); Yan Xun Liao, Kowloon (HK)

(21) Appl. No.: 14/749,669

(22) Filed: Jun. 25, 2015

(30) Foreign Application Priority Data
Jun. 26, 2014 (HK) 14106451.3

(51) Int. Cl. G08B 13/24

(52) U.S. Cl. CPC G08B 13/246; G08B 13/2468

(57) ABSTRACT

The present invention particularly relates to an RFID-based pre-sales/after-sales information collection and analysis system and an implementation method applied to the field of information identification technologies in the retail industry. The system includes an RFID tag, antennas, an RF module, and a cloud server, wherein the antennas transfer information with the RFID tag, and an electromagnetic signal is sent and received through the antennas so as to receive and send the information of the RFID tag, and transmit the information of the RFID tag to the cloud server through the RF module in time for storage and analysis. According to the present invention, a radio signal is applied to connect a plurality of antennas on a host of the RF module; in this way, the cost of a plurality of RF modules can be reduced into a single module, so as to realize the efficiency of a plurality of devices, thus reducing the costs of retail stores and various product marketing persons for purchasing and managing devices, and being capable of realizing the same functions.

### TECHNICAL FIELD

The present invention particularly relates to an RFID-based information collection and analysis system and an implementation method applied to the field of information identification technologies in the retail industry.

### BACKGROUND

A radio frequency identification technology (Radio Frequency

Identification, RFID) is a non-contact type automatic identification technology risen in 1990s. The RFID technology conducts non-contact two way communications using a radio frequency manner, so as to automatically identify a target object and acquire related data, and has many advantages such as high precision, strong environment adaptation, strong tamper resistance, fast and convenient operation, and the like. In normal automatic identification technologies at present, bar-codes and magnetic cards have lower costs, but are both easy to wear, and the data volumes thereof are very small. A contact type IC card is a little bit expensive, has a larger data storage volume and good security, but is also easy to wear and has a short service life. While a radio frequency card realizes contact-free operation, is convenient to use, has no mechanical wear, is long in service life, does not need a visible light source, has good penetrability as well as strong anti-pollution ability and endurance; moreover, it can work under a severe environment, has low requirements on the environment, has a far reading distance, can obtain data without being contacted with a target, support data writing, does not need to prepare a new tag, and can be repeatedly used; moreover, it uses an anti-collision technology, can identify high-speed moving objects and can identify a plurality of radio frequency cards at the same time. In recent years, RFID has been developed quickly at home and abroad, and there are a great many of RFID products. Those world-renowned factories like TI, Motorola, Philips, Microchip or the like all produce RFID products, which have their own characteristics and are uniquely in series. RFID has been widely applied to numerous fields like industrial automation, business automation, transportation control and management, such as traffic monitoring system for automobiles or trains, expressway automatic charging system, article management, flow line production automation, access control system, financial transactions, storage management, pasturage management, vehicle anti-theft, and the like. With the reduction of cost and implementation of standardization, it will be an irreversible trend to thoroughly spread and universally apply the RFID technology.

With the growing commercial competition, to effectively reduce the cost is an important means for the retail industry to strengthen its self competition, while one of the keys is to optimize management devices and analyze the purchasing preference of consumers, which determines the attention probability of the product through analyzing the purchasing intention and demand of customers in real time, thus improving the profit margin and reducing the inventory.

The design of the present RFID reader applied to the retail industry currently is to connect an antenna to an RF module using a cable or socket to form a complete set of RFID device, while multiple sets of devices (as shown in FIG. 1) possibly need to be installed at different positions, and the data read by RFID will be collected and stored in the device or transferred to a local computer. For the present RFID devices of the retail industry, a plurality of expensive RFID readers will be needed when using the RFID devices at different positions, while the major costs of the expensive RFID readers are due to the RF module, and the antenna only occupies a very small portion of the costs. In case of establishing a plurality of RFID data readers, the total costs will be surely high, which will certainly reduce the interests of numerous retailers to use a collection device that can analyze the presales behaviors of the customers, and give up applying RFID as an ideal mode to collect data.

### SUMMARY

The present invention provides an RFID-based pre-sales/after-sales information collection and analysis system and a method, which mainly connects a plurality of antennas on a host of an RF module via a radio manner to form a new RFID network, thus being capable of reducing the cost of a plurality of RF modules into a single module to realize the efficiency of a plurality of devices.

The invention employs the following technical solution.

An RFID-based pre-sales/after-sales information collection and analysis system includes:

an RFID tag configured to adhere to each product, collect and record related data information during the choosing and purchasing of a purchaser, for example, a frequency for a customer to select product information, length of time, and the like;

antennas distributed and installed on each counter and booth for placing the products, or mobile customized devices (for example, stock, box, carpet, and mirror), and configured to receive irradiation or radio waves from the RFID tag;

an RF module which is a remote control unit that controls various faraway devices using a “radio frequency” signal, and can command or drive other various corresponding machinery or electronic devices to finish various operations; and

a cloud server configured to analyze the data information collected, and provide some related information about preference and attention provided by a consumer during purchasing;

wherein the antennas transfer information with the RFID tag, and an electromagnetic signal is sent and received through the antennas so as to receive and send the information of the RFID tag, and transmit the information of the RFID tag to the cloud server through the RF module in time for storage and analysis

the RFID tag is configured to analyze the attention situations of the customer on the products in real time, and record such information of the customer such as residence time, and frequency for selecting various products, and the like.

the cloud server can record and analyze the effective information collected and transmitted by the RFID tag in real time;

the RFID-based pre-sales/after-sales information collection and analysis system further includes an RFID read-write identification device, the RFID read-write identification device is accessed to the cloud server directly or through a network, the RFID read-write identification device is configured to identify and read the information in the product RFID tag and feed the information back to the cloud server, the cloud server is configured to control the RFID read-write identification device to identify and read the related information in the product RFID tag through internally integrated sales management software thereof, update product status information in product informatization management data corresponding to the related information in a database system into the current status of the product according to the related information, and write a current flow record of the product, current times selected by the customer, frequencies purchased by the customer and the like, in the product informatization management data;

the network through which the cloud server is accessed to the database system is internet or LAN;

the RF module is an RFID tag identification module that integrates a microcontroller with a radio frequency sending-receiving circuit.

The present invention also provides an implementation method of an RFID-based pre-sales/after-sales information collection and analysis system, which includes the following steps of:

step 1: adhering an RFID tag on a product, setting antennas in a counter or cabinet of a retail place for placing the product, wherein the RFID tag can record the attention of a purchaser on the product at any time, for example: residence time, attention frequency and the like, and the antennas transfer energy and information with the RFID tag, and an electromagnetic signal is sent and received through the antennas so as to receive and send the information of the RFID tag;

step 2: setting an RF module in the sales place of an entire retail industry or each sales industry, wherein the antennas on the counters or cabinets in each sales place can transmit signals collected by the antennas in the counters or cabinets in each sales place to a cloud server through a radio signal manner, and the cloud server may also control an RFID read-write identification device to identify and read the related information in the product RFID tag through internally integrated sales management software thereof, update product status information in product informatization management data corresponding to the related information in a database system into the current status of the product according to the related information, and write a current flow record of the product, current times selected by a customer, frequencies purchased by the customer and the like, in the product informatization management data; step 3: setting the cloud server in a warehouse or other workroom, wherein the cloud server can feed the information back to sales personnel or officer in charge at any time; and

step 4: accessing, by the cloud server, the database system through a network, and conducting product sales distribution query, product inventory query, product sales statistics and product sales trend pre-statistics according to the entire or partial product informatization management data in the database system.

Compared with the related art, the present invention has the following advantageous and effective effects.

The present invention relates to a new RFID network, which mainly connects the plurality of antennas on the host of one RF module using a new distribution type multi-point radio sending-receiving technology, thus being capable of reducing the cost of the plurality of RF modules into a single module to realize the efficiency of the plurality of devices. The present invention enables the consumers to transmit and collect pre-sales information data more quickly and accurately, greatly reduces the inventories of the retailers, caters to the social development trends of the preference and attention of the consumers, improves the quality and efficiency of sales check and statistics performances of each industry, thus reducing the cost of the retail store or each sales place of the sales industry for purchasing the management device, and being also capable of realizing the same functions.

### BRIEF DESCRIPTION OF THE DRAWINGS

FIG. 1 is a block diagram of a conventional RFID device; and

FIG. 2 is a block diagram of an RFID-based pre-sales/after-sales information collection and analysis system according to the present invention.

Wherein, 1 refers to a cloud server, 2 refers to a reader, 3 refers to antennas, 4 refers to an RFID tag, and 5 refers to an RFID module.

### DETAILED DESCRIPTION

The present invention will be further described hereinafter with reference to the specific embodiment.

### First Embodiment

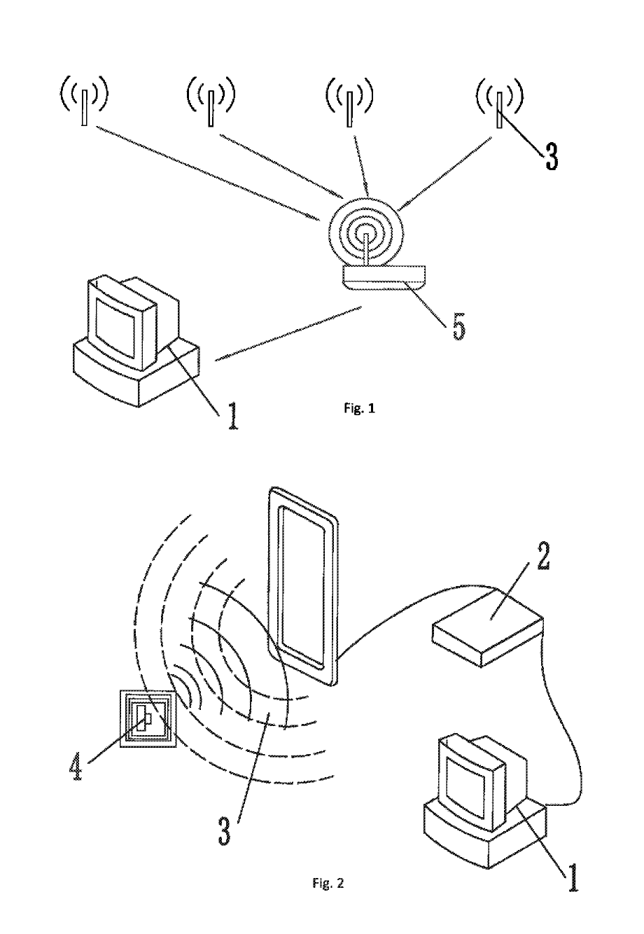

As shown in FIG. 1, a conventional RFID device includes antennas, a reader, a cloud server and an RFID tag, however, management is conducted with respect to one position only, and a plurality of readers need to be installed if conducting management at different positions. FIG. 2 shows an RFID-based information collection and analysis system, which is one embodiment of the present invention, including an RFID tag 4 configured to adhere to each product, collect and record related data information during the choosing and purchasing of a purchaser, for example, frequency, length of time, and the like; and the RFID tag 4 is configured to monitor the attention situations of customers on the products in real time, and record such information of the customers such as residence time, and frequency for selecting, and the like;

antennas 3 distributed on each counter and booth for placing the products, or mobile customized devices, and configured to receive irradiation or radio waves from the RFID tag 4;

an RF module 5 which is a remote control unit that controls various faraway devices using a radio frequency signal, and can command or drive other various corresponding machinery or electronic devices to finish various operations; and

a cloud server 1 configured to analyze the data information collected, and provide retailers with some related information about the purchasing inclination of consumers to the retailers, wherein the cloud server 1 may record and analyze effective information recorded by the RFID tag; wherein the antennas 3 transfer energy and information with the RFID tag 4, and an electromagnetic signal is sent and received through the antennas 3 so as to receive and send the information of the RFID tag 4, and transmit the information of the RFID tag 4 to the cloud server 1 through the RF module 5 in time for storage and analysis, and the network through which the cloud server 1 is accessed to the database system is internet or LAN.

### Second Embodiment

An RFID-based pre-sales/after-sales information collection and analysis system is a second embodiment of the present invention, wherein the difference between the second embodiment and the first embodiment is that: the RFID-based pre-sales/after-sales information collection and analysis system further includes an RFID read-write identification device, the RFID read-write identification device is accessed to the cloud server 1 directly or through network, the RFID read-write identification device is configured to identify and read the information in the product RFID tag 4 and feed the information back to the cloud server 1, and the cloud server 1 is configured to control the RFID read-write identification device to identify and read the related information in the product RFID tag 4 through internally integrated sales management software thereof, update product status information in product informatization management data corresponding to the related information in a database system into the current status of the product according to the related information, and write a current flow record of the product, current times selected by a customer, frequencies purchased by the customer and the like, in the product informatization management data.

### Third Embodiment

An RFID-based pre-sales/after-sales information collection and analysis system is a third embodiment of the present invention, wherein the difference between the third embodiment and the second embodiment is that: the RF module 5 is an RFID tag 4 identification module that integrates a microcontroller with a radio frequency sending-receiving circuit.

### Fourth Embodiment

An implementation method of an RFID-based pre-sales/after-sales information collection and analysis system includes the following steps. In step 1, an RFID tag 4 is adhered on a product, and antennas 3 are set in a counter or cabinet of a retail place for placing the product, wherein the RFID tag 4 can record the attention of a purchaser on the product at any time, for example: residence time, attention frequency and the like, and the antennas 3 transfer energy and information with the RFID tag 4, and an electromagnetic signal is sent and received through the antennas 3 so as to receive and send the information of the RFID tag 4. In step 2, an RF module 5 is set in the sales place of an entire retail industry or each sales industry, wherein the antennas 3 on the counters or cabinets of each sales place can transmit signals collected by the antennas 3 in the counters or cabinets of each sales place to a cloud server 1 through a radio signal manner, and the cloud server 1 can also control an RFID read-write identification device to identify and read the related information in the product RFID tag 4 through internally integrated sales management software thereof, update product status information in product informatization management data corresponding to the related information in a database system into the current status of the product according to the related information, and write a current flow record of the product, current times selected by a customer, frequencies purchased by the customer and the like, in the product informatization management data.

In step 3, the cloud server 1 is set in a warehouse or other workroom, wherein the cloud server can feed the information back to sales personnel or officer in charge at any time.

In step 4, the cloud server 1 accesses the database system through a network, and conducts product sales distribution query, product inventory query, product sales statistics and product sales trend pre-statistics according to the entire or partial product informatization management data in the database system.

Apparently, the foregoing embodiments of the present invention are merely to clearly explain the examples made by the present invention, rather than to limit the implementation manner of the present invention. Those having ordinary skills in the art may make other different forms of changes or alternations based on the foregoing explanations. All the implementation manners cannot be listed one by one here. Any apparent change or alternation derived from the technical solution of the present invention shall still fall within the protection scope of the present invention.

1. An RFID-based pre-sales/after-sales information collection and analysis system, characterized in that: comprising
an RFID tag configured to adhere to each product, collect and record related data information during the choosing and purchasing of the product, for example, a frequency for a customer to select product information, length of time, and the like;
antennas distributed and installed in each counter and booth for placing the products, or mobile customized devices, and configured to receive irradiation or radio waves from the RFID tag;
an RF module which is a remote control unit that controls various faraway devices using a “radio frequency” signal, and can command or drive other various corresponding machinery or electronic devices to finish various operations; and
a cloud server configured to analyze the data information collected, and provide retailers with some related information about preference and attention provided by a consumer during purchasing;
wherein the antennas transfer information with the RFID tag, and an electromagnetic signal is sent and received through the antennas so as to receive and send the information of the RFID tag, and transmit the information of the RFID tag to the cloud server through the RF module in time for storage and analysis.

2. The RFID-based pre-sales/after-sales information collection and analysis system according to claim 1, characterized in that: the RFID tag is configured to analyze the attention situations of the customer on the products in real time, and record such information of the customer such as residence time, and frequency for selecting various products, and the like.

3. The RFID-based pre-sales/after-sales information collection and analysis system according to claim 2, characterized in that: the RFID-based pre-sales/after-sales information collection and analysis system further comprises an RFID read-write identification device, the RFID read-write identification device is accessed to the cloud server directly or through a network, the RFID read-write identification device is configured to identify and read the information in the product RFID tag and feed the information back to the cloud server, the cloud server is configured to control the RFID read-write identification device to identify and read the related information in the product RFID tag through internally integrated sales management software thereof; update product status information in product informatization management data corresponding to the related information in a database system into the current status of the product according to the related information, and write a current flow record of the product, current times selected by the customer, frequencies purchased by the customer and the like, in the product informatization management data.

4. The RFID-based pre-sales/after-sales information collection and analysis system according to claim 3, characterized in that: the network through which the cloud server is accessed to the database system is internet or LAN.

5. The RFID-based pre-sales/after-sales information collection and analysis system according to claim 4, characterized in that: the RF module is an RFID tag identification module that integrates a microcontroller with a radio frequency sending-receiving circuit.

6. An implementation method of an RFID-based pre-sales/after-sales information collection and analysis system, characterized in that: the method employs the information collection and analysis system according to claim 1, and comprises the following steps of:
step 1: adhering an RFID tag on a product, setting antennas in a counter or cabinet of a retail store for placing the product, wherein the RFID tag can record the attention of a purchaser on the product at any time, for example: residence time, attention frequency and the like, and the antennas transfer information with the RFID tag, and an electromagnetic signal is sent and received through the antennas so as to receive and send the information of the RFID tag;
step 2: setting an RF module in the sales place of an entire retail industry or each sales industry, wherein the antennas on the counters or cabinets in each sales place can transmit signals collected by the antennas in the counters or cabinets in each sales place to a cloud server through a radio signal manner, and the cloud server may also control an RFID read-write identification device to identify and read the related information in the product RFID tag through internally integrated sales management software thereof, update product status information in product informatization management data corresponding to the related information in a database system into the current status of the product according to the related information, and write a current flow record of the product, current times selected by a customer, frequencies purchased by the customer and the like, in the product informatization management data; and
step 3: setting the cloud server in a warehouse or other workroom, wherein the cloud server can feed the information back to sales personnel or officer in charge at any time.

7. The implementation method of the RFID-based pre-sales/after-sales information collection and analysis system according to claim 6, characterized in that: the method further comprises step 4: accessing, by the cloud server, the database system through a network, and conducting product sales distribution query, product inventory query, product sales statistics and product sales trend pre-statistics according to the entire or partial product informatization management data in the database system.
